(19) United States
(12) Patent Application Publication
(10) Pub. No.: US 2024/0014518 A1
(43) Pub. Date: Jan. 11, 2024

(54) Secondary Battery and Battery Module Including the Same

(71) Applicant: LG Energy Solution, Ltd., Seoul (KR)

(72) Inventor: Jong Hun Kim, Daejeon (KR)

(73) Assignee: LG Energy Solution, Ltd., Seoul (KR)

(21) Appl. No.: 18/035,009

(22) PCT Filed: Apr. 12, 2022
(86) PCT No.: PCT/KR2022/005266

§ 371 Date: May 2, 2023

(30) Foreign Application Priority Data
Apr. 13, 2021 (KR) 10-2021-0048035
Mar. 30, 2022 (KR) 10-2022-0039739

(51) Int. Cl. H01M 50/533; H01M 50/103; H01M 50/15; H01M 50/171; H01M 50/595; H01M 50/54; H01M 50/209; H01M 50/51; H01M 50/512

(52) U.S. Cl. CPC H01M 50/533; H01M 50/103; H01M 50/15; H01M 50/171; H01M 50/595; H01M 50/54; H01M 50/209; H01M 50/51; H01M 50/512

(57) ABSTRACT

A rechargeable battery include: an electrode stack that includes a first electrode, a second electrode, and a separator disposed therebetween; and a battery case that accommodates the electrode stack. The battery case includes a first case and a second case, and the first case and the second case are bonded by an insulation bonding portion to seal an inner space of the battery case. The first electrode includes a first electrode current collector and a first electrode active material-layer, and the second electrode includes a second electrode current collector and a second electrode active material layer. The first electrode current collector includes a first protruded portion protruded in a first direction, and the second electrode current collector includes a second protruded portion protruded in a second direction. The first protruded portion is bonded to the first case, and the second protruded portion is bonded to the second case.

### CROSS-REFERENCE TO RELATED APPLICATIONS

This application is a national phase entry under 35 U.S.C. § 371 of International Application No. PCT/2022/005266 filed on Apr. 12, 2022, which claims priority to and the benefit of Korean Patent Application No. 10-2021-0048035 filed in the Korean Intellectual Property Office on Apr. 13, 2021, and Korean Patent Application No. 10-2022-0039739 filed in the Korean Intellectual Property Office on Mar. 30, 2022, the entire contents of which are incorporated herein by reference in their entireties.

### TECHNICAL FIELD

The present invention relates to a rechargeable battery and a battery module including the same, and more specifically, it relates to a rechargeable battery having a novel structure and a battery module including the same.

### BACKGROUND ART

Recently, due to the depletion of fossil fuels, the price of an energy source is increased and interest in environmental pollution is greatly increased, and the demand for an eco-friendly alternative energy source is becoming an essential factor for the future. Accordingly, research on various power production technologies, such as nuclear power, solar power, wind power, and tidal power, is continuing, and power storage devices for using the generated energy more efficiently are also of great interest.

In particular, as technology development and demand for mobile devices increase, the demand for batteries as an energy source is rapidly increasing, and accordingly, a lot of research on batteries capable of meeting various needs is being conducted.

The rechargeable battery includes, for example, a nickel cadmium battery, a nickel hydrogen battery, a nickel zinc battery, and a lithium rechargeable battery. Among them, lithium rechargeable battery has been widely used since it has little memory effect compared to nickel-based rechargeable battery, is free to charge and discharge, has very low self-discharge rate, high operation voltage, and high energy density per unit weight. That is, there is a high demand for lithium rechargeable batteries such as lithium ion batteries and lithium ion polymer batteries that have merits such as high energy density, discharge voltage, and output stability.

The rechargeable battery can be classified into a pouch-type rechargeable battery in which an electrode assembly is embedded in a pouch-type case of a laminate sheet and a can-type rechargeable battery in which an electrode assembly is embedded in a can of metallic material according to the shape of the case. The can in the can-type rechargeable battery may be cylindrical or prismatic. That is, the can-type rechargeable battery may be further classified into a cylindrical battery and a prismatic battery.

Among them, the cylindrical battery has a merit of having a relatively large capacity and structural stability, but it is not easy to arrange it in a stacked structure due to its external characteristics. In addition, there is a high possibility that distortion occurs during charging and discharging compared to other types of batteries. In the case of a prismatic battery, it has excellent durability and is suitable for mass production, but there are drawbacks in that it weighs a lot and heat dissipation is difficult because an aluminum can is used. The pouch-type battery has a merit of being able to diversify its shape because it is light in weight and easy to process, but has a drawback of high production cost compared to square and cylindrical batteries.

In addition, the rechargeable battery may be classified according to the structure of the electrode assembly in which a positive electrode, a negative electrode, and a separator interposed between the positive and negative electrodes are stacked. Representatively, a jelly roll-type electrode assembly having a structure in which long sheet-shaped positive and negative electrodes are wound with a separator interposed therebetween, a stack-type electrode assembly having a structure in which a plurality of positive and negative electrodes cut into units of a predetermined size are sequentially placed with a separator interposed therebetween and stacked, and the like

Recently, in order to solve the problem of the jelly-roll type electrode assembly and the stack-type electrode assembly, as a mixed form of the jelly roll type and stack type, a stack/folding type electrode assembly having a structure in which unit cells in which positive and negative electrodes of a predetermined unit are stacked with a separator interposed therebetween are placed on a separation film and then sequentially wound has been developed.

In the case of the jelly-roll type electrode assembly, since a long sheet is spirally wound, wasted space is generated when the electrode assembly is accommodated in a case, and thus the energy density may be lowered. In addition, there is a possibility that distortion and swelling may occur during charging and discharging for a long time. Meanwhile, in the case of a stack-type electrode assembly, there is a merit that a high-capacity rechargeable battery can be manufactured by minimizing the remaining space inside the case.

### DISCLOSURE

### Technical Problem

The task to be solved by the present invention is to provide a rechargeable battery that forms a novel structure using a stack-type electrode assembly, and a battery module including the same.

However, the problems to be solved by the embodiments of the present invention are not limited to the above-described problems and can be variously expanded in the range of technical ideas included in the present invention.

### Technical Solution

A rechargeable battery according to an embodiment of the present invention includes: an electrode stack that includes a first electrode, a second electrode, and a separator disposed between the first electrode and the second electrode; and a battery case that accommodates the electrode stack. The battery case includes a first case and a second case, and the first case and the second case are bonded by an insulation bonding portion to seal an inner space of the battery case accommodating the electrode stack. The first electrode includes a first electrode current collector and a first electrode active material layer formed on one or both sides of the first electrode current collector, and the second electrode includes a second electrode current collector and a second electrode active material layer formed on one or both sides of the second electrode current collector. The first electrode current collector includes a first protruded portion protruded in a first direction, and the second electrode current collector includes a second protruded portion protruded in a second direction. The first protruded portion is bonded to the first case, and the second protruded portion is bonded to the second case.

The insulation bonding portion may bond the first case and the second case and may simultaneously maintain electrical insulation between the first case and the second case.

The first case and the second case may include a metal material.

The insulation bonding portion may be an insulation paste coating portion or an insulation welding portion.

The rechargeable battery may further include a first insulation member positioned between the first protruded portion and the second case and a second insulation member positioned between the second protruded portion and the first case.

The first insulation member and the second insulation member may be an insulation tape or an insulation paste coating layer.

The first electrode and the second electrode each may be included in the electrode stack in plural, the first protruded portions of the first electrodes may be bonded to each other, and the second protruded portions of the second electrodes may be bonded to each other.

Among the first protruded portions, a first protruded portion positioned closest to one side of the first case may be bonded to the one side of the first case.

The rechargeable battery may further include a first insulation member that is positioned between a first protruded portion farthest from one side of the first case and one side of the second case. The side of the first case and the side of the second case may be positioned opposite to each other with the electrode stack interposed therebetween.

With reference to a direction perpendicular to the one side of the second case, the first insulation member may wholly cover the first protruded portion farthest from the one side of the first case among the first protruded portion.

A second protruded portion closest to one side of the second case among the second protruded portions may be bonded to the one side of the second case.

The rechargeable battery may further include a second insulation member that is positioned between a second protruded portion farthest from one side of the second case among the second protruded portions, and one side of the first case. The one side of the first case and the one side of the second case may be positioned opposite to each other with the electrode stack interposed therebetween.

With reference to a direction that is perpendicular to the one side of the first case, the second insulation member may wholly cover the second protruded portion farthest from the one side of the second case among the second protruded portions.

The battery case may be in the form of a polyhedron with an inner space in which the electrode stack is accommodated.

The battery case may be in the form of a hexahedron with an inner space in which the electrode stack is accommodated.

The first case and the second case may be bonded by the insulation bonding portion to form the battery case of the hexahedron.

A battery module according to an embodiment of the present invention includes a plurality of rechargeable batteries, and the rechargeable batteries may be electrically connected by contacting a battery cases with each other.

The first case of one rechargeable battery and the second case of the other rechargeable battery may contact and thus electrical series connection between the rechargeable batteries may be established.

The first case of one rechargeable battery and the first case of another rechargeable battery may contact or the second case of one rechargeable battery and the second case of the other rechargeable battery may contact and thus electrical parallel connection between the rechargeable batteries may be established.

### Advantageous Effects

According to the embodiments of the present invention, the battery case itself may function as an electrode terminal by disposing the electrode stack inside the battery case and electrically connecting the battery case and the electrode stack. Therefore, without a separate member, it is possible to implement electrical connection between rechargeable batteries by disposing the rechargeable batteries such that the battery cases are in contact with each other.

Effects of the present invention are not limited to the effects mentioned above, and other effects not mentioned will be clearly understood by a person of an ordinary skill in the art from the description of the claimed range.

### DESCRIPTION OF THE DRAWINGS

FIG. 1 is a perspective view of a rechargeable battery according to an embodiment of the present invention.

FIG. 2 is an exploded perspective view of the rechargeable battery of FIG. 1.

FIG. 3 is a perspective view of an electrode stack included in the rechargeable battery of FIG. 2.

FIG. 4 is a cross-sectional view of FIG. 1, taken along the line A-A′.

FIG. 5 is a cross-sectional view that shows a disposal of rechargeable batteries according to an embodiment of the present invention.

FIG. 6 is a cross-sectional view that shows a disposition of rechargeable batteries according to another embodiment of the present invention.

FIG. 7 is a cross-sectional view that shows the arrangement of rechargeable batteries according to another embodiment of the present invention.

FIG. 8 and FIG. 9 are an exploded perspective view and a cross-sectional view of a rechargeable battery according to a modified embodiment of the present invention.

FIG. 10 and FIG. 11 are an exploded perspective view and a cross-sectional view of a rechargeable battery according to a modified embodiment of the present invention.

FIG. 12 is a perspective view that shows the disposition of a plurality of rechargeable batteries corresponding to FIG. 10 and FIG. 11.

FIG. 13 is an exploded perspective view that illustrates a rechargeable battery according to an embodiment of the modified present invention.

FIG. 14 is a perspective view that shows the disposition of a plurality of rechargeable batteries corresponding to FIG. 13.

FIG. 15 is an exploded perspective view that illustrates a rechargeable battery according to an embodiment of the modified present invention.

### MODE FOR INVENTION

Hereinafter, with reference to the accompanying drawing, various embodiments of the present invention will be described in detail and thus a person of an ordinary skill can easily perform it in the technical field to which the present invention belongs. The present invention may be implemented in several different forms and is not limited to the embodiments described herein.

The drawings and description are to be regarded as illustrative in nature and not restrictive. Like reference numerals designate like elements throughout the specification.

In the drawings, size and thickness of each element are arbitrarily illustrated for convenience of description, and the present invention is not necessarily limited to as illustrated in the drawings. In the drawings, the thickness of layers, films, panels, regions, and the like are exaggerated for clarity. In addition, in the drawings, for better understanding and ease of description, the thicknesses of some layers and regions are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, throughout the specification, the word “on” a target element will be understood to be positioned above or below the target element, and will not necessarily be understood to be positioned “at an upper side” based on an opposite to gravity direction.

In addition, unless explicitly described to the contrary, the word “comprise”, and variations such as “comprises” or “comprising”, will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

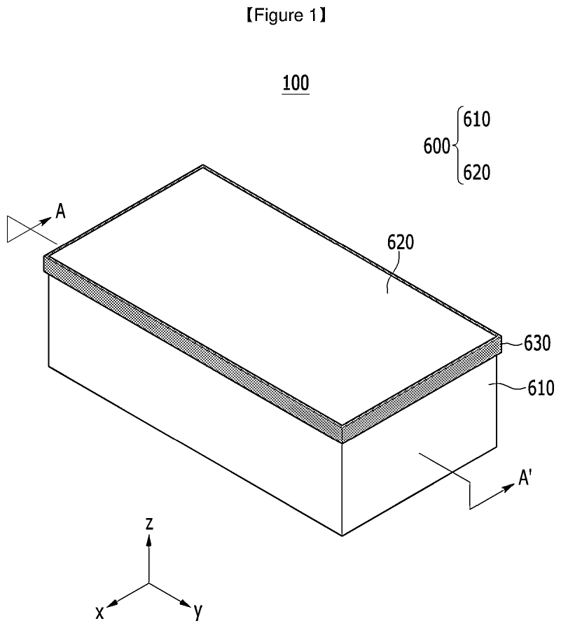

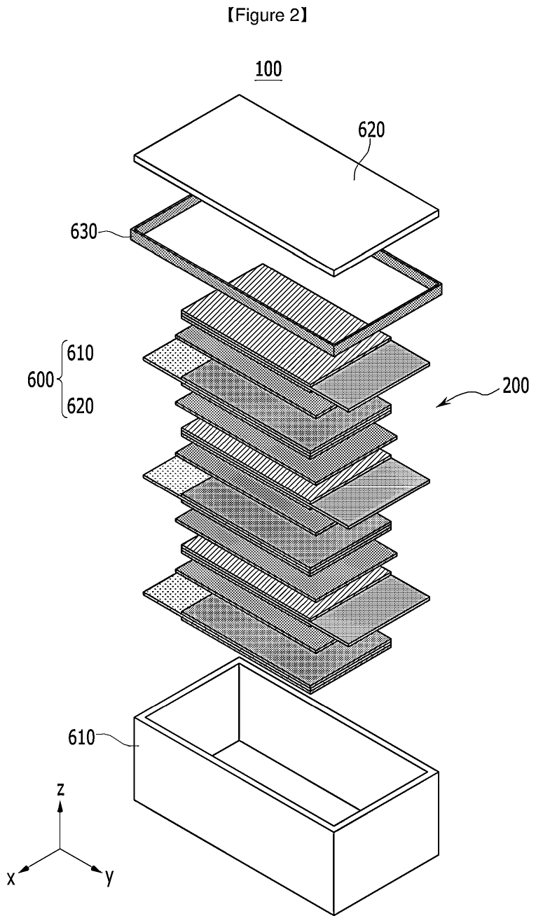

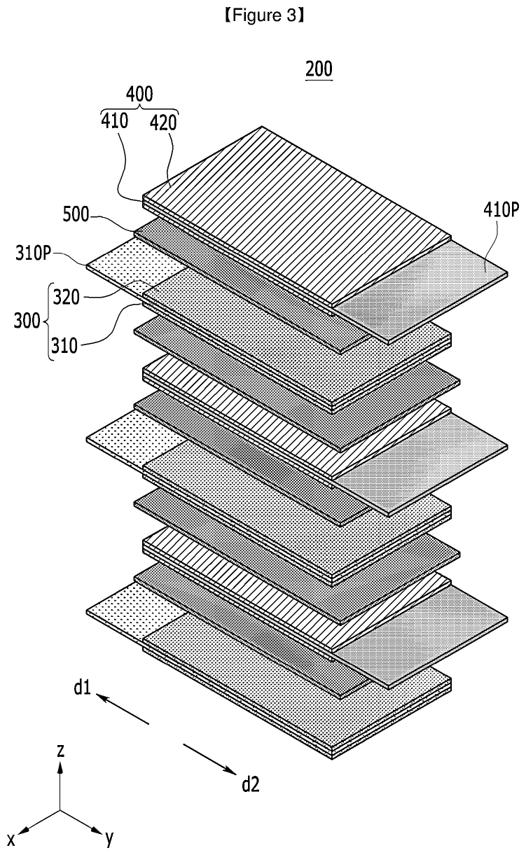

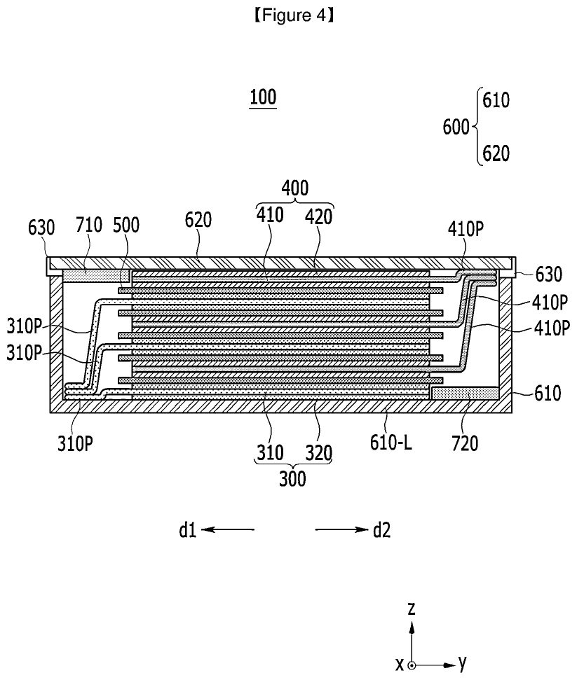

FIG. 1 is a perspective view of a rechargeable battery according to an embodiment of the present invention. FIG. 2 is an exploded perspective view of the rechargeable battery of FIG. 1. FIG. 3 is a perspective view of an electrode stack included in the rechargeable battery of FIG. 2. FIG. 4 is a cross-sectional view of FIG. 1, taken along the line A-A′.

Referring to FIG. 1 to FIG. 4, a rechargeable battery 100 according to an embodiment of the present invention includes an electrode stack 200 and a battery case 600 that accommodates the electrode stack 200. The battery case 600 includes a first case 610 and a second case 620, and the first case 610 and the second case 620 are bonded by an insulation bonding portion 630 such that an inner space of the battery case 600, in which the electrode stack 200 is accommodated, is sealed. That is, corners of the first case 610 and corners of the second case 620 corresponding to each other are bonded by the insulation bonding portion 630 to form the battery case 600 in which the inner space is sealed, and the electrode stack 200 may be accommodated in the inner space.

There is no particular limitation on the shape of the first case 610 and the second case 620 as long as the battery case 600 having an internal space by them being bonded to each other can be formed. For example, the first case 610 may be in the form of a prismatic can with one side open. The electrode stack 200 may be accommodated in the inner space of the first case 610. On the other hand, for example, the second case 620 may have a plate shape, and may be disposed to cover the open side of the first case 610. That is, the four side surfaces and the lower surface of the electrode stack 200 may be covered by the first case 610, and the upper surface of the electrode stack 200 may be covered by the second case 620. Here, the four sides of the electrode stack 200 indicate planes of the x-axis direction, the −x-axis direction, the y-axis direction, the −y-axis direction on the drawing, respectively, and the upper and lower surfaces of the electrode stack 200 indicate planes of the z-axis direction and −z-axis direction on the drawing, respectively. The present invention is described according to the above-stated standard, but this is only for convenience of explanation, and may vary depending on the position of the object or the position of the observer.

The insulation bonding portion 630 may be positioned between the corners corresponding to each other between the first case 610 and the second case 620. For example, the insulation bonding portion 630 may be positioned between upper corner portions of the first case 610 and the four sides of the second case 620. The insulation bonding portion 630 may include a material having electrical insulation and adhesive properties. The insulation bonding portion 630 may simultaneously bond the first case 610 and the second case 620, and maintain electrical insulation between the first case 610 and the second case 620.

As an example, the insulation bonding portion 630 may be an insulation paste coating portion. More specifically, the insulation bonding portion 630 may be a ceramic paste coating portion formed by coating a ceramic paste on at least one of the first case 610 and the second case 620 and bonding them to each other. That is, the insulation bonding portion 630 may include a ceramic paste. For example, the ceramic paste may contain fillers and binders. The ceramic paste may be manufactured by mixing a binder and the like with the filler of the ceramic material.

The filler may include one or more materials selected from a group consisting of silica, alumina, aluminum nitride, boron nitride, mullite, clay, zircon, mica, and a magnesium oxide. The binder may include one or more materials selected from a group consisting of sodium silicate, phosphate, magnesium oxysulfate, and aluminum phosphate. However, these are just examples of the materials, and there is no particular limitation on the material as long as a ceramic paste having electrical insulation and adhesion can be manufactured.

As another example, the insulation bonding portion 630 may be an insulation welding portion. In particular, the insulation bonding portion 630 may be a ceramic welding portion. That is, the insulation bonding portion 630 may be a portion in which the first case 610 and the second case 620 are bonded using a ceramic welding method. A conventional ceramic welding method may be applied to the insulation bonding portion 630 of the present invention. As an example of the ceramic welding method, refractory powder, fuel powder, and oxidizing gas are injected into a portion where welding is needed, and the fuel powder is combusted to generate sufficient heat. As a result, the refractory powder is melted or softened, and the cohesive refractory material adheres to a surface of a welding target.

The refractory powder may include at least one powder selected from the group consisting of calcium oxide, silica, zirconia, magnesia, alumina, and a chromium oxide. For the oxidizing gas, oxygen can be used.

The fuel powder may include at least one powder selected from a group consisting of silicon, aluminum, magnesium, chromium, and zirconium. The material of the fuel powder becomes an excellent fireproof material upon combustion. Specifically, aluminum or zirconium provides an amphoteric oxide such as alumina or zirconia, and magnesium or chromium provides a basic oxide such as magnesia or chromium oxide. The fuel powder contributes to the formation of a refractory material with high corrosion resistance.

In summary, the first case 610 and the second case 620 are bonded to each other via the insulation bonding portion 630, and simultaneously, the first case 610 and the second case 620 are electrically isolated from each other by the insulation bonding portion 630.

On the other hand, in order to strengthen the electrical insulation between the first case 610 and the second case 620, an insulation spacer and the like may be additionally disposed.

Hereinafter, the electrode stack 200 according to the present embodiment will be described in detail.

The electrode stack 200 includes a first electrode 300, a second electrode 400, and a separator 500 positioned between the first electrode 300 and the second electrode 400. Specifically, the first electrode 300 and the second electrode 400 are sequentially stacked with the separator 500 interposed therebetween to prepare the electrode stack 200. The electrode stack 200 in the present embodiment may be a stack-type electrode assembly in which the first electrode 300, the separator 500, and the second electrode 400 are stacked along one direction. More specifically, the electrode stack 200 may be in a form in which the first electrode 300, the separator 500, the second electrode 400, and the other separator 500 are repeated and stacked.

The first electrode 300 may include a first electrode current collector 310 and a first electrode active material layer 320 formed on one or both surfaces of the first electrode current collector 310. Specifically, the first electrode active material layer 320 may be formed by coating an electrode active material on one or both surfaces of the first electrode current collector 310. In addition, the first electrode current collector 310 according to the present embodiment may include a first protruded portion 310P protruded in a first direction d1. That is, an exposed portion of the first electrode current collector 310, which is not coated with the electrode active material, is protruded in the first direction d1 such that the first protruded portion 310P may be provided.

The second electrode 400 includes a second electrode active material layer 420 and a second electrode current collector 410 formed on one or both surfaces of the second electrode current collector 410. Specifically, the second electrode active material layer 420 may be formed by coating an electrode active material on one or both surfaces of the second electrode current collector 410. In addition, the second electrode current collector 410 according to the present embodiment may include a second protruded portion 410P protruded in a second direction d2. That is, an exposed portion of the second electrode current collector 410, which is not coated with the electrode active material, is protruded in the second direction d2 to provide the second protrude portion 410P.

The first direction d1 and the second direction d2 are directions that do not coincide with each other, and for example, as shown in FIG. 3, the directions may be opposite to each other.

Meanwhile, one of the first electrode 300 and the second electrode 400 may be a positive electrode, and the other may be a negative electrode. For example, the first electrode current collector 310 and the first electrode active material layer 320 may be a positive electrode current collector and a positive active material layer, and the second electrode current collector 410 and the second electrode active material layer 420 may be a negative electrode current collector and a negative active material layer.

Hereinafter, referring to FIG. 3 and FIG. 4, the connection relationship between the electrode stack, the first case, and the second case according to the present embodiment will be described in detail.

Referring to FIG. 3 and FIG. 4, the first protruded portion 310P is bonded to one surface of the first case 610, and the second protruded portion 410P is bonded to one surface of the second case 620. Particularly, as shown in the drawing, when the first case 610 is in the form of a prismatic can with one side open and the second case 620 is in the form of a plate, the first protruded portion 310P may be bonded to the lower surface 610-L of the first case 610.

The first electrode 300 and the second electrode 400 each may be provided in plural and included in the electrode stack 200, respectively. That is, in the electrode stack 200, the first electrode 300 and the second electrode 400 may each be stacked in plural. For example, in FIG. 3 and FIG. 4, the three first electrodes 300 and the three second electrodes 400 are sequentially stacked with the separator 500 interposed therebetween. In this case, the first protruded portions 310P protruded along the first direction d1 may be bonded to each other, and the second protruded portions 410P protruded along the second direction d2 may be bonded to each other.

The bonded first protruded portions 310P may be finally bonded to one surface of the first case 610. In particular, the first protruded portion 310P positioned closest to one surface of the first case 610 among the first protruded portions 310P may contact and be bonded to one surface of the first case 610. In FIG. 4, as an example, a state in which the first protruded portion 310P positioned closest to the lower surface 610-L of the first case 610 among the first protruded portions 310P is bonded to the lower surface 610-L of the first case 610 is shown.

The bonded second protruded portions 410P may be finally bonded to one surface of the second case 620. Particularly, among the second protruded portions 410P, the second protruded portion 410P positioned closest to one surface of the second case 620 may contact and be bonded to the second case 620.

In the bonding between the protruded portions or the bonding between the protruded portion and the first or second case, when electrical connection between the two components is possible, there is no particular limitation on the bonding method, but welding bonding is preferably used.

Meanwhile, the rechargeable battery 100 according to the present embodiment may further include a first insulation member 710 positioned between first protruded portion 310P and the second case 620 and a second insulation member 720 positioned between the second protruded portion 410P and the first case 610. The first insulation member 710 and the second insulation member 720 include a material that is an electrical insulator, and for example, may be an insulation tape or insulation paste coating layer.

The insulating tape may be a normal tape that is electrically insulating. That is, an insulating tape is attached to one side of the second case 620 and thus the first insulation member 710 according to the present embodiment can be provided, and another insulating tape is attached to one side of the first case 610 and thus the second insulation member 720 according to the present embodiment can be provided.

As another embodiment, the insulating paste coating layer may be a ceramic paste coating layer formed by coating ceramic paste. The ceramic paste may contain fillers and binders. The ceramic paste may be manufactured by mixing a binder and the like with the filler of the ceramic material. The filler may include at least one of silica, alumina, aluminum nitride, boron nitride, mullite, clay, zircon, mica, and a magnesium oxide. The binder may include at least one of sodium silicate, phosphate, magnesium oxysulfate, and aluminum phosphate.

The ceramic paste is coated on one side of the second case 620 to provide the first insulation member 710 according to the present embodiment, and the ceramic paste is also coated on one side of the first case 610 to provide the second insulation member 720 according to the present embodiment.

The first insulation member 710 may be positioned between a first protruded portion 310p farthest from one surface of the first case 610 among the first protruded portions 310p and one surface of the second case 620. In this case, the one surface of the first case 610 is a surface to which one of the first protruded portions 310P is in contact and bonded, and the one surface of the second case 620 is a surface to which one of the second protruded portions 410P is in contact and bonded. The side of the first case 610 and the side of the second case 620 may be positioned opposite to each other with the electrode stack 200 interposed therebetween. In FIG. 4, the one surface of the first case 610 is illustrated as the lower surface 610-L of the first case 610.

In addition, with reference to a direction that is perpendicular to the one surface of the second case 620, the first insulation member 710 may wholly cover the first protruded portion 310p farthest from one surface of the first case 610 among the first protruded portions 310p. The contact of the first protruded portion 310P farthest from the one surface of the first case 610 among the first protruded portions 310P with the second case 620 is restricted by the first insulation member 710.

In addition, the second insulation member 720 may be positioned between a second protruded portion 410p farthest from the one surface of the second case 620 among the second protruded portions 410P and the one surface of the first case 610. As described above, the one surface of the first case 610 is a surface to which one of the first protruded portions 310P is in contact and bonded, and the one surface of the second case 620 is a surface to which one of the second protruded portions 410P is in contact and bonded. The one surface of the first case 610 and the one surface of the second case 620 may be positioned opposite to each other with the electrode stack 200 interposed therebetween.

In addition, with reference to a direction that is perpendicular to the one surface of the first case 610, the second insulation member 720 may wholly cover the second protruded portion 410p farthest from the one surface of the second case 620 among the second protruded portions 410P. The contact of the second protruded portion 410P farthest from the second case 620 among the second protruded portions 410P with the first case 610 is restricted by the second insulation member 720.

In summary, the first protruded portions 310p are connected with the first case 610 and simultaneously contact with the second case 620 is limited. In addition, the second protruded portions 410P are connected to the second case 620 and simultaneously contact with the first case 610 is limited. Accordingly, the first case 610 and the second case 620 serve as electrode terminals of the rechargeable battery 100. For this, the first case 610 and the second case 620 preferably include a metal material having excellent electrical conductivity. There is no particular limitation on the metal material, but for example, copper (Cu), aluminum (Al), and the like may be applied.

For example, when the first electrode 300 is a positive electrode and the second electrode 400 is a negative electrode, the first case 610 functions as a positive terminal, and the second case 620 functions as a negative terminal.

According to the present embodiment, the first electrode 300 and the second electrode 400 are layered to form the electrode stack 200, and then the first protruded portions 310P are bonded to the first case 610 and the second protruded portions 410P are bonded to the second case 620 such that the first case 610 and the second case 620 can be used as electrode terminals. Without a separate notching process or electrode tab attachment process for the first electrode current collector 310 or the second electrode current collector 410, an electrode terminal of the rechargeable battery 100 can be provided simply by accommodating the electrode stack 200 and bonding the protruded portions 310P and 410P to each part of the battery case 600.

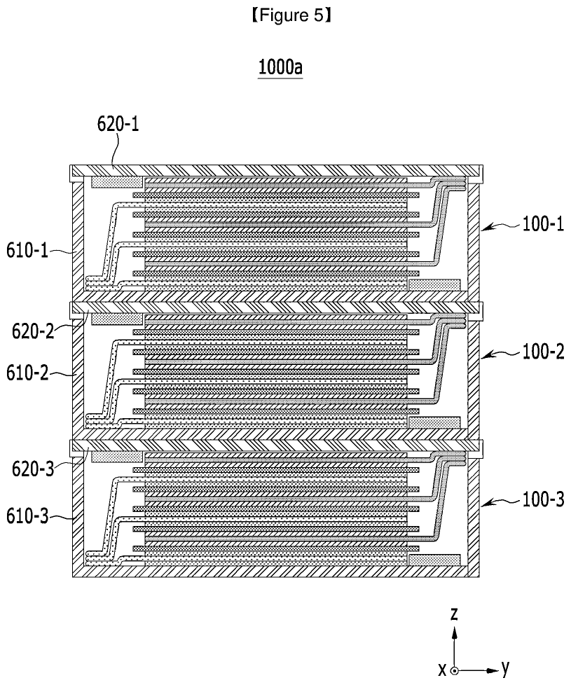

FIG. 5 is a cross-sectional view that shows a disposal of rechargeable batteries according to an embodiment of the present invention.

Referring to FIG. 5 together with FIG. 4, a battery module 1000a according to an embodiment of the present invention includes a plurality of rechargeable batteries 100-1, 100-2, and 100-3, and the rechargeable batteries 100-1, 100-2, and 100-3 are electrically connected by contacting a battery case 600 with each other. That is, since a first case and a second case function as electrode terminals of the rechargeable battery, rechargeable batteries can be electrically connected by contacting the battery cases.

For example, first cases 610-1 and 610-2 of any one of the rechargeable batteries 100-1 and 100-2 and second cases 620-2 and 620-3 of the other rechargeable batteries 100-2 and 100-3 make contact, and thus an electrical series connection between the rechargeable batteries 100-1, 100-2, and 100-3 can be established.

Specifically, the first case 610-1 of the first rechargeable battery 100-1 and the second case 620-2 of the second rechargeable battery 100-2 may be disposed to contact. In addition, the first case 610-2 of the second rechargeable battery 100-2 and the second case 620-3 of the third rechargeable battery 100-3 may be disposed to contact.

As described above, the rechargeable batteries 100-1, 100-2, and 100-3 are disposed such that the cases are in contact with each other, and thus the electrical series connection between the rechargeable batteries 100-1, 100-2, and 100-3 can be realized. That is, the rechargeable battery according to the present embodiment has the merit of being able to form an electrical series connection by contact arrangement between cases without a separate member or additional process.

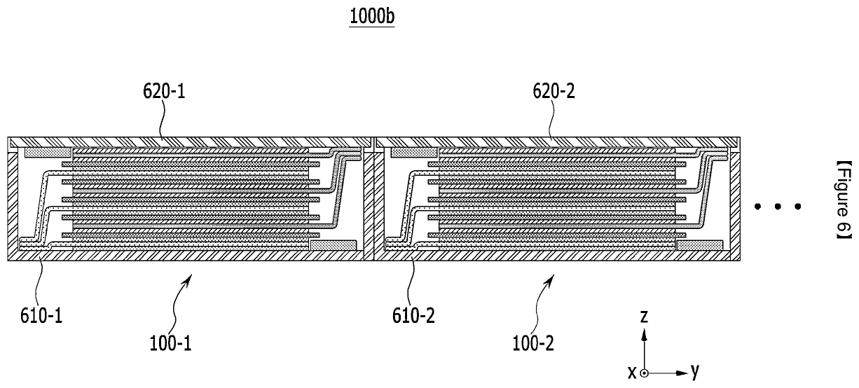

Meanwhile, FIG. 6 is a cross-sectional view that shows a disposition of rechargeable batteries according to another embodiment of the present invention.

Referring to FIG. 6, a battery module 1000b according to another embodiment of the present invention includes a plurality of rechargeable batteries 100-1 and 100-2, and the rechargeable batteries 100-1 and 100-2 are electrically connected by contacting battery cases 600 with each other.

In this case, a first case 610-1 of any one rechargeable battery 100-1 and a first case 610-2 of another rechargeable battery 100-2 contact each other, or a second case of any one rechargeable battery and a second case of another rechargeable battery contact each other such that an electrically parallel connection between the rechargeable batteries (100-1 and 100-2) may be established.

Specifically, in FIG. 6, the disposition in which the first case 610-1 of the first rechargeable battery 100-1 and the first case 610-2 of the second rechargeable battery 100-2 are in contact with each other is illustrated. Additionally, another rechargeable battery may be disposed for an electrically parallel connection. Meanwhile, the contact form between the second cases of each rechargeable battery will be described later below.

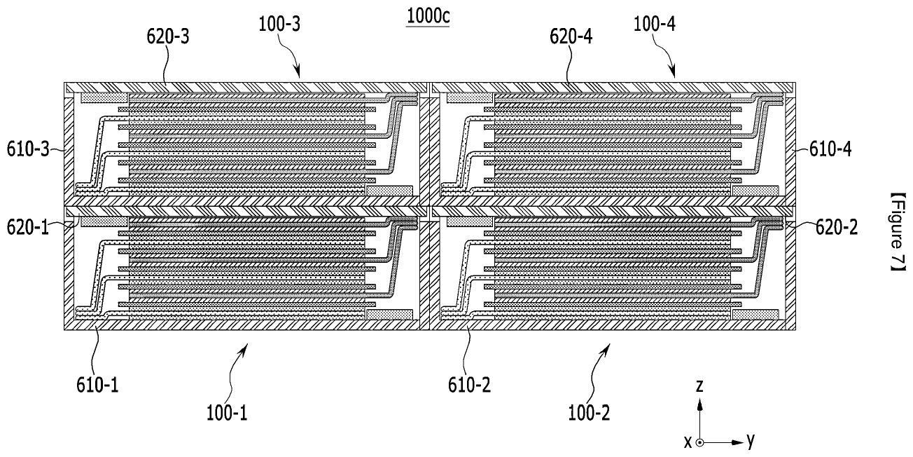

FIG. 7 is a cross-sectional view that shows the arrangement of rechargeable batteries according to another embodiment of the present invention.

Referring to FIG. 7, a battery module 1000c according to another embodiment of the present invention includes a plurality of rechargeable batteries 100-1, 100-2, 100-3, and 100-4, and the rechargeable batteries 100-1, 100-2, 100-3, and 100-4 are connected with each other for each battery case 600 and electrically connected.

In this case, the first case 610-3 of the third rechargeable battery 100-3 and the second case 620-1 of the first rechargeable battery 100-1 contact and an electrical series connection may be established, and the first case 610-4 of the fourth rechargeable battery 100-4 and the second case 620-2 of the second rechargeable battery 100-2 contact and an electrical series connection may be established.

Simultaneously, the first case 610-1 of the first rechargeable battery 100-1 and the first case 610-2 of the second rechargeable battery 100-2 contact and thus an electrical series connection may be established, and the first case 610-3 of the third rechargeable battery 100-3 and the first case 610-4 of the fourth rechargeable battery 100-4 contact and an electrical series connection may be established.

In such a way, a mixture of parallel electrical connection and serial electrical connection between the rechargeable batteries 100-1, 100-2, 100-3, and 100-4 is also possible by controlling the arrangement shape of the rechargeable batteries 100-1, 100-2, 100-3, and 100-4.

In summary, the arrangement formed between the rechargeable batteries and the contact formed between the battery cases are adjusted in the battery modules 1000a, 1000b, and 1000c according to the present embodiments such that electrical series connection, electrical parallel connection, or a mixture form thereof between the rechargeable batteries can be established without a separate member or additional process.

Hereinafter, various forms of the battery case included in the rechargeable battery according to the present invention will be described.

Referring back to FIG. 2 to FIG. 4, a battery case 600 in the present invention may be in the form of a polyhedron having an internal space in which the electrode stack 200 is accommodated. In particular, the battery case 600 may be in the form of a hexahedron having an internal space in which the electrode stack 200 is accommodated. Specifically, the first case 610 and the second case 620 are bonded by the insulation bonding portion 630 such that a hexahedral battery case 600 can be formed.

In the present invention, there is no limit to the number or area of a plane of the first case 610 and a plane of the second case 620 among the hexahedron of the battery case 600, and various embodiments can be applied. For example, as described above, the first case 610 shown in FIG. 2 to FIG. 4 may be in the form of a prismatic can with one side open, and the second case 620 may be in the form of a plate. That is, the first case 610 may form five planes of the planes of the hexahedral battery case 600, and the second case 620 may form the remaining one plane of the battery case 600.

Since there is no limit to the number or area of the planes of the first case 610 and the plane of the second case 620, hereinafter, the modified battery cases will be described.

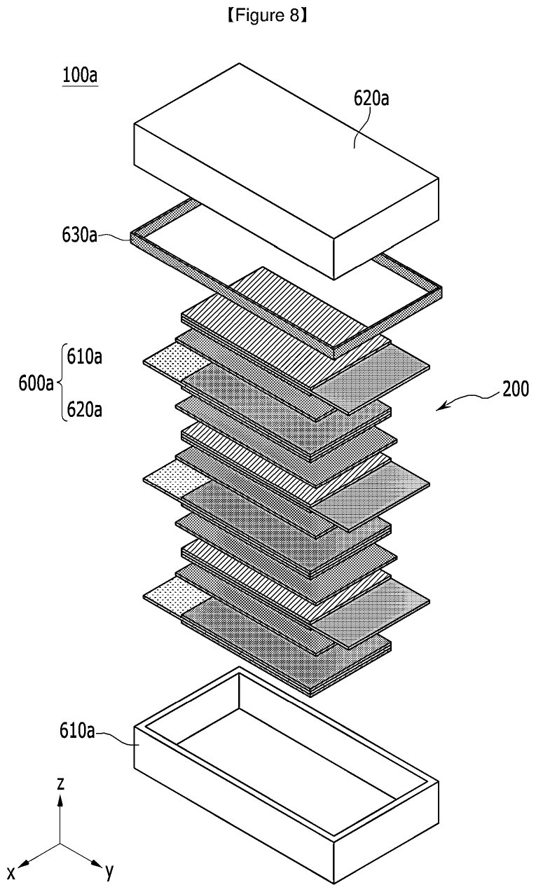

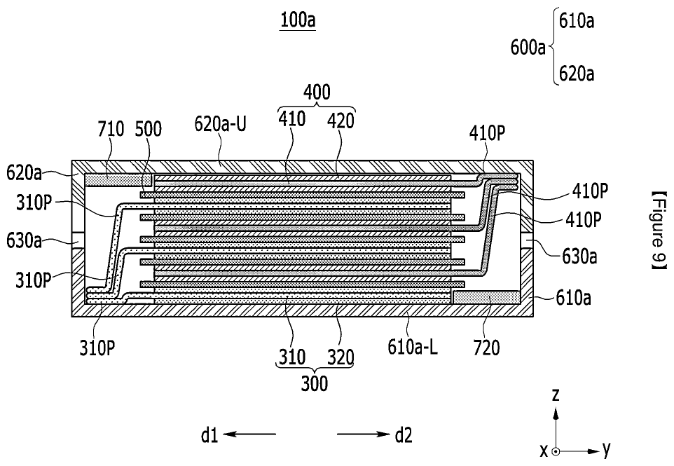

FIG. 8 and FIG. 9 are an exploded perspective view and a cross-sectional view of a rechargeable battery according to a modified embodiment of the present invention. Specifically, FIG. 9 is a cross-sectional view of a rechargeable battery 100a of FIG. 8 cut along the y-z plane after being assembled.

Referring to FIG. 8 and FIG. 9, a rechargeable battery 100a according to a modified embodiment of the present invention includes an electrode stack 200 and a battery case 600a. The electrode stack 200 including a first electrode 300, a second electrode 400, and a separator may have the same or similar structure as the electrode stack in the embodiment described above, and a description thereof will be omitted.

The battery case 600a includes a first case 610a and a second case 620a. The first case 610a and the second case 620a are bonded by an insulation bonding portion 630a, and an inner space of the battery case 600a in which the electrode stack 200 is accommodated is sealed.

Even in the present embodiment, the battery case 600a may be in the form of a polyhedron having an inner space in which the electrode stack 200 is accommodated. In particular, the battery case 600a may be in the form of a hexahedron having an inner space in which the electrode stack 200 is accommodated. However, both the first case 610a and the second case 620a may be in the form of a prismatic can with one side open. The first case 610a has an open side facing upward, while the second case 620a has the same shape as the first case 610a but may be positioned such that the open side faces downward. An insulation bonding portion 630a is provided at the corresponding corners of the first case 610a and the second case 620a and thus the first case 610a and the second case 620a can be bonded to each other. With reference to a height direction (a direction that is parallel to the z-axis), the insulation bonding portion 630a may be positioned in the middle of the battery case 600a.

First protruded portions 310P bonded to each other may be bonded to one surface of the first case 610a, and second protruded portions 410P bonded to each other may be bonded to one surface of the second case 620a. In particular, the first protruded portions 310P may be bonded to a lower surface portion 610a-L of the first case 610a, and the second protruded portions 410P may be bonded to an upper surface portion 620a-U of the second case 620a.

In the present embodiment, since the boundary between the first case 610a and the second case 620a functioning as each electrode terminal is in the middle of the height of the battery case 600a, the electrical-parallel connection through the side contact between the rechargeable batteries 100a is difficult to apply in practice. Instead, since the boundary is positioned in the middle, there is little risk that the first protruded portions 310P contact the second case 620a having a different polarity or the second protruded portions 410P contact the first case 610a having a different polarity. That is, it can be more stable in an internal short.

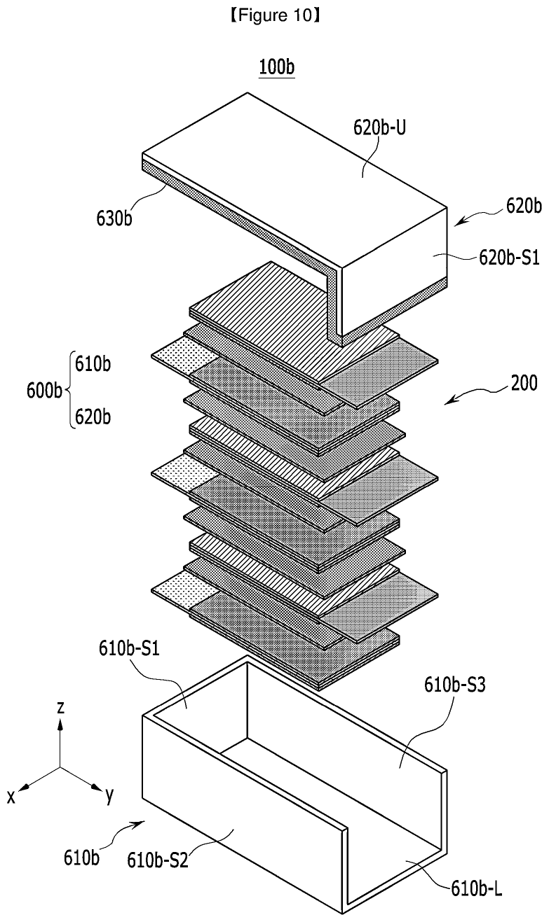

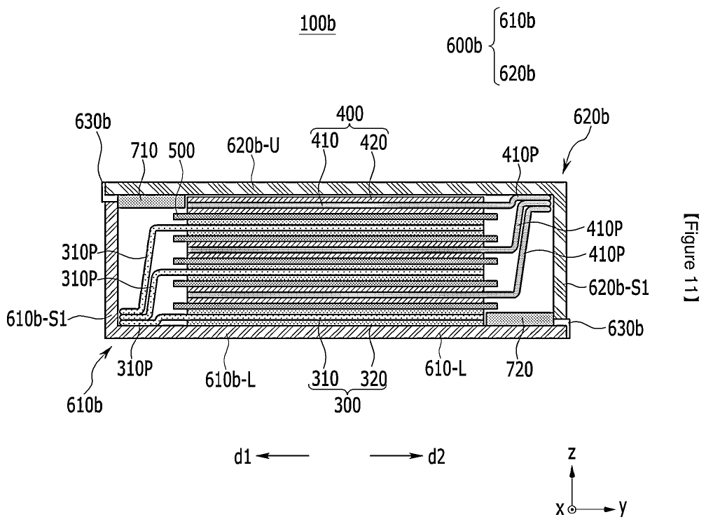

FIG. 10 and FIG. 11 are an exploded perspective view and a cross-sectional view of a rechargeable battery according to a modified embodiment of the present invention. Specifically, FIG. 11 is a cross-sectional view of a rechargeable battery 100b of FIG. 10 cut along the y-z plane after being assembled.

Referring to FIG. 10 and FIG. 11, a rechargeable battery 100b according to a modified embodiment of the present invention includes an electrode stack 200 and a battery case 600b. The electrode stack 200 including a first electrode 300, a second electrode 400, and a separator may have the same or similar structure as the electrode stack in the embodiment described above, and a description thereof will be omitted.

The battery case 600b includes a first case 610b and a second case 620b. The first case 610b and the second case 620b are bonded by an insulation bonding portion 630b, and an inner space of the battery case 600b in which the electrode stack 200 is accommodated is sealed.

Even in the present embodiment, the battery case 600a may be in the form of a polyhedron having an internal space in which the electrode stack 200 is accommodated. In particular, the battery case 600b may be in the form of a hexahedron having an inner space in which the electrode stack 200 is accommodated.

In this case, a first case 610b may include a lower surface portion 610b-L and three side portions 610b-S1, 610b-S2, and 610b-S3, and a second case 620b may include one upper surface portion 620b-U and one side portion 620b-S1. That is, in the present embodiment, the first case 610b may form four surfaces among the surfaces of the battery case 600b, and the second case 620b may form the remaining two surfaces of the battery case 600b. An insulation bonding portion 630b is provided at the corresponding corners of the first case 610b and the second case 620b such that the first case 610b and the second case 620b can be bonded to each other.

First protruded portions 310P bonded to each other may be bonded to one surface of the first case 610b, and second protruded portions 410P bonded to each other may be bonded to one surface of the second case 620b. In particular, the first protruded portions 310P may be bonded to a lower surface portion 610b-L of the first case 610b, and the second protruded portions 410P may be bonded to an upper surface portion 620b-U of the second case 620b.

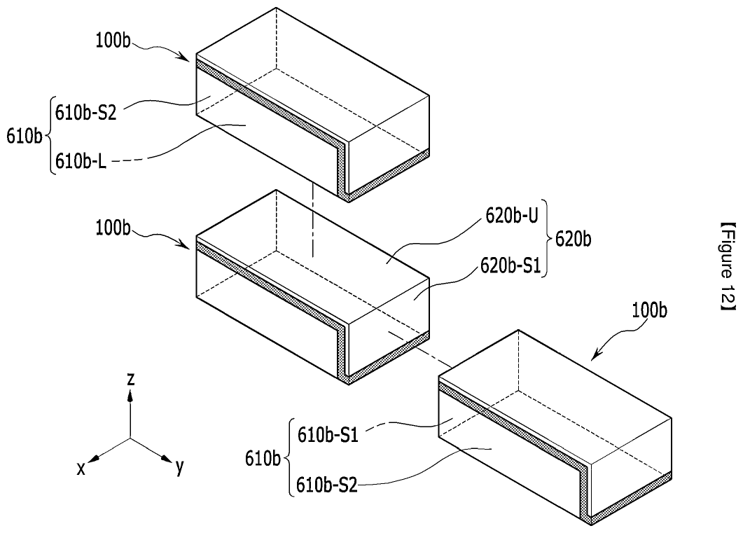

FIG. 12 is a perspective view that shows the disposition of a plurality of rechargeable batteries corresponding to FIG. 10 and FIG. 11.

Referring to FIG. 10 to FIG. 12, the rechargeable batteries 100b can be electrically connected by contacting battery cases with each other. For example, the upper surface portion 620b-U of the second case 620b of one rechargeable battery 100b and the lower surface portion 610b-L of the first case 610b of the other rechargeable battery 100b are in contact to form an electrical series connection. In addition, the side portion 620b-S1 of the second case 620b of any one rechargeable battery 100b and the side portion 610b-S1 of the first case 610b of the other rechargeable battery 100b are contacted to form an electrical series connection. On the other hand, although not specifically illustrated, in some cases, the side portions 620b-S1 of the second case 620b are in contact with each other, or the side portions 610b-S1, 610b-S2, and 610b-S3 of the first case 610b are in contact with each other such that the rechargeable batteries are in contact with each other, thereby enabling electrical parallel connection to be established.

The form shown in FIG. 12 is an example of the disposal form between the rechargeable batteries 100b, and it is possible to dispose of various rechargeable batteries 100b as needed by utilizing the area where the first case 610b and the second case 620b are formed.

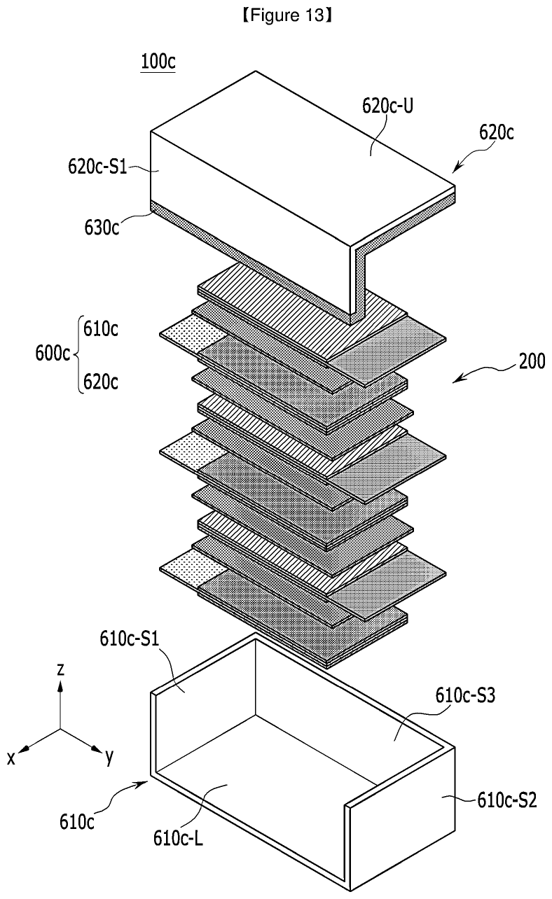

FIG. 13 is an exploded perspective view that illustrates a rechargeable battery according to an embodiment of the modified present invention.

Referring to FIG. 13, a rechargeable battery 100c according to a modified embodiment of the present invention includes an electrode stack 200 and a battery case 600c. The electrode stack 200 may have the same or similar structure as the electrode stack in the embodiment described above, and a description thereof will be omitted.

The battery case 600c includes a first case 610c and a second case 620c. The first case 610c and the second case 620c are bonded by an insulation bonding portion 630c, and an inner space of the battery case 600c in which the electrode stack 200 is accommodated is sealed.

Even in the present embodiment, the battery case 600c may be in the form of a polyhedron having an internal space in which the electrode stack 200 is accommodated. In particular, the battery case 600c may be in the form of a hexahedron having an internal space in which the electrode stack 200 is accommodated.

In this case, the first case 610c may include a lower surface portion 610c-L and three side portions 610c-S1, 610c-S2, and 610c-S3, and the second case 620c may include one upper surface portion 620c-U and one side portion 620c-S1. That is, in the present embodiment, the first case 610c may form four surfaces among the surfaces of the battery case 600c, and the second case 620c may form the remaining two surfaces of the battery case 600c. An insulation bonding portion 630c is provided at the corresponding corners of the first case 610c and the second case 620c such that the first case 610c and the second case 620c can be bonded to each other. The rechargeable battery 100c of the present embodiment is different from the rechargeable battery 100 described with reference to FIG. 10 and FIG. 11 in a position where the side portion 620c-S1 of the second case 620c is formed.

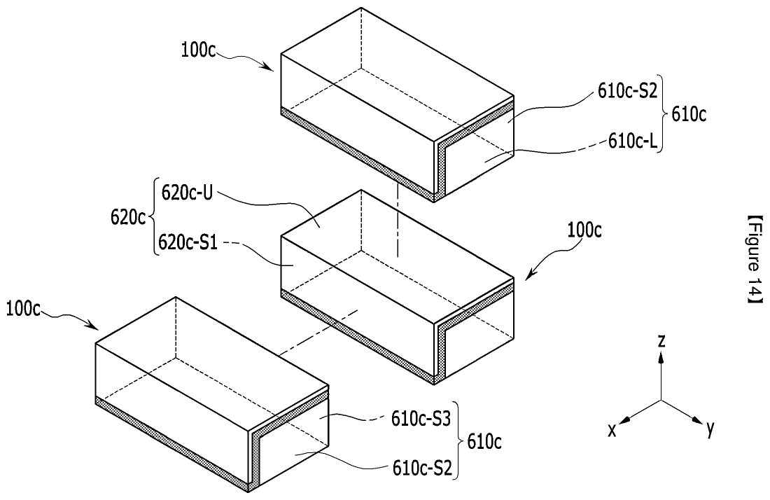

FIG. 14 is a perspective view that shows the disposition of a plurality of rechargeable batteries corresponding to FIG. 13.

Referring to FIG. 13 and FIG. 14, the rechargeable batteries 100c can be electrically connected by contacting battery cases with each other. For example, the upper surface portion 620c-U of the second case 620c of one rechargeable battery 100c and the lower surface portion 610c-L of the first case 610c of the other rechargeable battery 100c are in contact to form an electrical series connection. In addition, the side portion 620c-S1 of the second case 620c of any one rechargeable battery 100c and the side portion 610c-S1 of the first case 610c of the other rechargeable battery 100c are contacted to form an electrical series connection. On the other hand, although not specifically illustrated, in some cases, the side portions 620c-S1 of the second case 620c are in contact with each other, or the side portions 610c-S1, 610c-S2, and 610c-S3 of the first case 610c are in contact with each other such that the rechargeable batteries are in contact with each other, thereby enabling electrical parallel connection to be established.

The form shown in FIG. 14 is an example of the disposition form between the rechargeable batteries 100c, and it is possible to dispose of various rechargeable batteries 100c as needed by utilizing the area where the first case 610c and the second case 620c are formed.

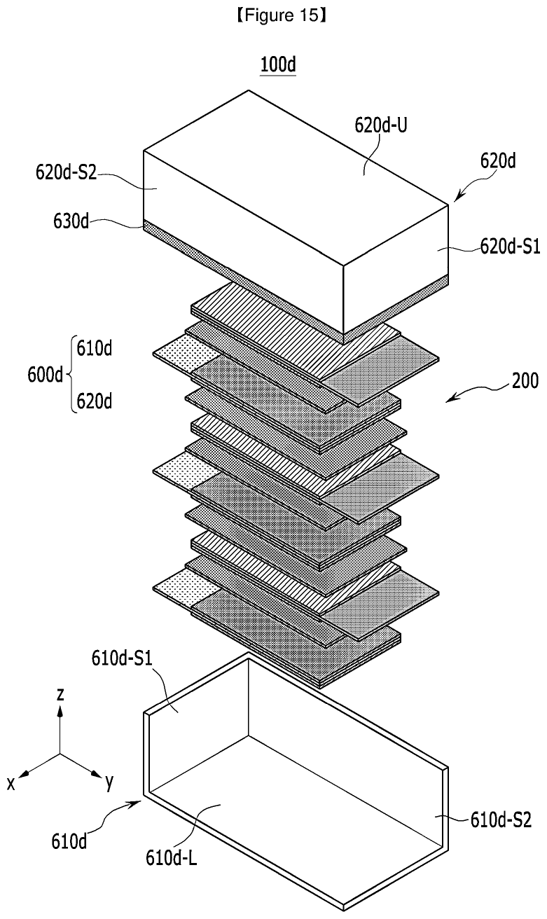

FIG. 15 is an exploded perspective view that illustrates a rechargeable battery according to an embodiment of the modified present invention.

Referring to FIG. 15, a rechargeable battery 100d according to a modified embodiment of the present invention includes an electrode stack 200 and a battery case 600d. The battery case 600d includes a first case 610d and a second case 620d. The first case 610d and the second case 620d are bonded by an insulation bonding portion 630d, and an inner space of the battery case 600d in which the electrode stack 200 is accommodated is sealed.

Even in the present embodiment, the battery case 600d may be in the form of a polyhedron having an internal space in which the electrode stack 200 is accommodated. In particular, the battery case 600d may be in the form of a hexahedron having an internal space in which the electrode stack 200 is accommodated.

In this case, the first case 610d may include a lower surface portion 610d-L and two side portions 610d-S1 and 610d-S2, and the second case 620d may include one upper surface portion 620d-U and two side portions 620d-S1. That is, in the present embodiment, the first case 610d may form three surfaces among the surfaces of the battery case 600d, and the second case 620d may form the remaining three surfaces of the battery case 600d. An insulation bonding portion 630d is provided at the corresponding corners of the first case 610d and the second case 620d such that the first case 610d and the second case 620d can be bonded to each other.

The first case 610d may contact a battery case of other rechargeable batteries through the lower surface portion 610d-L and the two side portions 610d-S1 and 610d-S2, and the second case 620d may also contact a battery case of other rechargeable batteries through the upper surface portion 620d-U and the two side portions 620d-S1 and 620d-S2.

Referring to various embodiments of the present described with reference to FIG. 5 to FIG. 15, when the plurality of rechargeable batteries 100, 100a, 100b, 100c, and 100d of the present invention are assembled to form a battery module, the arrangements and electrical connection of the rechargeable batteries 100, 100a, 100b, 100c, and 100d can be easily adjusted and modified by applying a variety of rechargeable batteries 100, 100a, 100b, 100c, and 100d that are different in configuration area of the first case and the second case in the battery case. That is, although the inner space of the battery module is not standardized and limited, it has the merit of being able to easily modify the arrangement of rechargeable batteries and the form of electrical connection accordingly. Such a merit can be derived because the first case and the second case of the battery case function as the electrode terminal of the rechargeable battery, and electrical series or parallel connection can be established by contact between the battery cases.

In the present embodiment, terms indicating direction such as front, rear, left, right, up, and down area used, but these terms are for convenience of explanation only, and may vary depending on the position of the object or the position of the observer.

One or more battery modules according to the present embodiment described above may be mounted together with various control and protection systems such as a battery management system (BMS), a battery disconnect unit (BDU), and a cooling system to form a battery pack.

The rechargeable battery, the battery module, or the battery pack can be applied to various devices. Specifically, it can be applied to transportation means such as electric bicycles, electric vehicles, hybrids, or an ESS (Energy Storage System), but is not limited thereto and can be applied to various devices that can use a rechargeable battery.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100, 100a, 100b, 100c, 100d: rechargeable battery
200: electrode stack
600, 600a, 600b, 600c, 600d: battery case
610, 610a, 610b, 610c, 610d: first case
620, 620a, 620b, 620c, 620d: second case
630, 630a, 630b, 630c, 630d: insulation bonding portion
310P: first protruded portion
410P: second protruded portion
1000a, 1000b, 1000c: battery module

1. A rechargeable battery comprising:
an electrode stack that includes a first electrode, a second electrode, and a separator disposed between the first electrode and the second electrode; and
a battery case that accommodates the electrode stack,
wherein the battery case comprises a first case and a second case,
the first case and the second case are bonded by an insulation bonding portion to seal an inner space of the battery case accommodating the electrode stack,
the first electrode includes a first electrode current collector and a first electrode active material layer formed on one or both sides of the first electrode current collector,
the second electrode comprises a second electrode current collector and a second electrode active material layer formed on one or both sides of the second electrode current collector,
the first electrode current collector comprises a first protruded portion protruded in a first direction,
the second electrode current collector comprises a second protruded portion protruded in a second direction,
the first protruded portion is bonded to the first case, and
the second protruded portion is bonded to the second case.

2. The rechargeable battery of claim 1, wherein
the insulation bonding portion bonds the first case and the second case and simultaneously maintains electrical insulation between the first case and the second case.

3. The rechargeable battery of claim 1, wherein
the first case and the second case comprise a metal material.

4. The rechargeable battery of claim 1, wherein
the insulation bonding portion is an insulation paste coating portion or an insulation welding portion.

5. The rechargeable battery of claim 1, further comprising a first insulation member positioned between the first protruded portion and the second case and a second insulation member positioned between the second protruded portion and the first case.

6. The rechargeable battery of claim 5, wherein
the first insulation member and the second insulation member are an insulation tape or an insulation paste coating layer.

7. The rechargeable battery of claim 1, wherein
the first electrode and the second electrode are each included in the electrode stack in plural,
the first protruded portions of the first electrodes are bonded to each other, and
the second protruded portions of the second electrodes are bonded to each other.

8. The rechargeable battery of claim 7, wherein
among the first protruded portions, a first protruded portion positioned closest to one side of the first case is bonded to the one side of the first case.

9. The rechargeable battery of claim 7, further comprising a first insulation member that is positioned between a first protruded portion farthest from one side of the first case and one side of the second case,
wherein the one side of the first case and the one side of the second case are positioned opposite to each other with the electrode stack interposed therebetween.

10. The rechargeable battery of claim 9, wherein
with reference to a direction perpendicular to the one side of the second case, the first insulation member wholly covers the first protruded portion farthest from the one side of the first case among the first protruded portion.

11. The rechargeable battery of claim 7, wherein
a second protruded portion closest to one side of the second case among the second protruded portions is bonded to the one side of the second case.

12. The rechargeable battery of claim 7, further comprising a second insulation member that is positioned between a second protruded portion farthest from one side of the second case among the second protruded portions, and one side of the first case,
wherein the one side of the first case and the one side of the second case are positioned opposite to each other with the electrode stack interposed therebetween.

13. The rechargeable battery of claim 12, wherein
with reference to a direction that is perpendicular to the one side of the first case, the second insulation member wholly covers the second protruded portion farthest from the one side of the second case among the second protruded portions.

14. The rechargeable battery of claim 1, wherein
the battery case is in the form of a polyhedron with an inner space in which the electrode stack is accommodated.

15. The rechargeable battery of claim 1, wherein
the battery case is in the form of a hexahedron with an inner space in which the electrode stack is accommodated.

16. The rechargeable battery of claim 15, wherein
the first case and the second case are bonded by the insulation bonding portion to form the battery case of the hexahedron.

17. A battery module comprises the rechargeable battery of claim 1 in plural, and
the rechargeable batteries are electrically connected by contacting the battery cases with each other.

18. The battery module of claim 17, wherein
the first case of one rechargeable battery and the second case of another rechargeable battery contact and thus an electrical series connection between the rechargeable batteries is established.

19. The battery module of claim 17, wherein
the first case of one rechargeable battery and the first case of another rechargeable battery contact or the second case of one rechargeable battery and the second case of the other rechargeable battery contact and thus establish an electrical parallel connection between the rechargeable batteries.
